(19) United States
(12) Patent Application Publication
(10) Pub. No.: US 2008/0165088 A1
(43) Pub. Date: Jul. 10, 2008

(54) Plasma display panel

(76) Inventors: Shi-Ok Kwon, Suwon-si (KR); Hyun Soh, Suwon-si (KR); Joong-Ho Moon, Suwon-si (KR); Jin-Won Han, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/898,242

(22) Filed: Sep. 11, 2007

(30) Foreign Application Priority Data
Jan. 8, 2007 (KR) 10-2007-0002013

(51) Int. Cl. G09G 3/28

(52) U.S. Cl. 345/60

(57) ABSTRACT

A plasma display panel having increased brightness may be obtained by employing front and rear substrates having different transmittances. The plasma display panel includes a front substrate, a rear substrate that faces the front substrate, the rear substrate having a transmittance different from the front substrate, barrier ribs that partition a space between the front and rear substrates to define discharge cells, display electrodes that extend in a first direction corresponding to the discharge cells, and address electrodes that extend in a second direction that crosses the first direction to cross the display electrodes at the discharge cells.

### BACKGROUND OF THE INVENTION

1. Field of the Invention

The embodiments relate to a plasma display panel (PDP). More particularly, the embodiments relate to a PDP that is capable of improving brightness of a screen.

2. Description of the Related Art

A PDP is a display element for displaying images by employing visible light generated by exciting a photoluminescent layer with ultra-violet light emitted from a plasma obtained via gas discharge. Since the PDP may be constructed to have a large screen with high resolution, the PDP has been spotlighted as a next generation flat panel display apparatus.

A general structure of the PDP may include a three electrode surface discharge type structure in which a pair of electrodes on an inner surface of a front substrate may face address electrodes on an inner surface of a rear substrate spaced apart from the front substrate. The electrodes may correspond to discharge cells.

In the PDP, tens to millions of discharge cells may be arranged in an array, depending on size. The discharge cells to be turned on may be selected by using a memory characteristic, and images may be displayed by discharging the selected discharge cells.

Visible light generated by emission of a photoluminescent material may be emitted through at least one of the substrates. As the transmittance of the substrate increases, the brightness of a screen may improve. However, since the visible light is emitted not only in a direction in which the images are displayed, but also in a direction in which the images are not displayed, a loss of visible light may occur.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present embodiments are therefore directed to a PDP which substantially overcomes one or more problems due to the limitations and disadvantages of the related art.

It is therefore a feature of an embodiment of the present invention to provide a PDP that is capable of reducing a loss of visible light.

At least one of the above and other features and advantages of the present invention may be realized by providing a PDP including a front substrate, a rear substrate facing the front substrate, the rear substrate having a transmittance different from the front substrate, barrier ribs that partition a space between the front and rear substrates to define discharge cells, display electrodes that extend in a first direction corresponding to the discharge cells, and address electrodes that extend in a second direction that crosses the first direction to cross the display electrodes at the discharge cells.

The transmittance of the front substrate may be greater than that of the rear substrate. The front and rear substrates may be glass substrates. The front substrate may be thinner than the rear substrate. The thickness of the front substrate may be about 1.8 mm, and the thickness of the rear substrate may be about 2.8 mm. The transmittance of the front substrate may be equal to or greater than about 93%, and the transmittance of the rear substrate is equal to or less than about 90%. The transmittance of the front substrate and the dielectric layer may be equal to or greater than about 70%. A dielectric layer covering the address electrodes may be on the rear substrate, and the transmittance of the rear substrate and the dielectric layer may be equal to or less than about 30%. The barrier ribs may include first barrier ribs that define the discharge cells in the second direction, and when an interval between neighboring first barrier ribs is w1 and a width of each address electrode is w2, a ratio of 0.6≦w2/w1≦1.36 may be satisfied. The front and rear substrates may be made of different materials. The rear substrate may be colored with an achromatic color.

At least one of the above and other features and advantages of the present invention may be realized by providing a PDP, which may include a front substrate, a rear substrate that faces the front substrate, barrier ribs that partition a space between the front and rear substrates to define discharge cells, display electrodes that extend in a first direction corresponding to the discharge cells, and address electrodes that extend in a second direction that crosses the first direction to cross the display electrodes at the discharge cells, where the barrier ribs include barrier ribs that define the discharge cells in the second direction, and where when an interval between neighboring first barrier ribs is w1 and a width of each address electrode is w2, a ratio of 0.6≦w2/w1≦1.36 is satisfied.

The transmittance of the front substrate may be greater than that of the rear substrate. The front and rear substrates may be glass substrates. The front substrate may be thinner than the rear substrate. A thickness of the front substrate may be about 1.8 mm, and a thickness of the rear substrate may be about 2.8 mm. A transmittance of the front substrate may be equal to or greater than about 93%, and a transmittance of the rear substrate may be equal to or less than about 90%. A transmittance of the front substrate and the dielectric layer may be equal to or greater than about 70%. A dielectric layer covering the address electrodes may be on the rear substrate, and a transmittance of the rear substrate and the dielectric layer may be equal to or less than about 30%. The front and rear substrates may be made of different materials.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial perspective view of a PDP according to an embodiment of the present invention;

FIG. 2 illustrates a partial top plan view of an arrangement of display electrodes and discharge cells of the PDP of FIG. 1; and

FIG. 3 illustrates a relationship between a width of an address electrode and a discharge cell.

### DETAILED DESCRIPTION OF THE INVENTION

Korean Patent Application No. 10-2007-0002013, filed on Jan. 8, 2007, in the Korean Intellectual Property Office, and entitled: “Plasma Display Panel,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

In accordance with the embodiments, the brightness of a PDP may be increased by constructing the front and rear substrates so that the transmittances of the front and rear substrates are different from each other. The brightness of the PDP may be increased by reflecting the visible light that is transmitted toward the rear substrate back toward the front substrate by optimizing the width of the address electrode in consideration of the interval between neighboring barrier ribs.

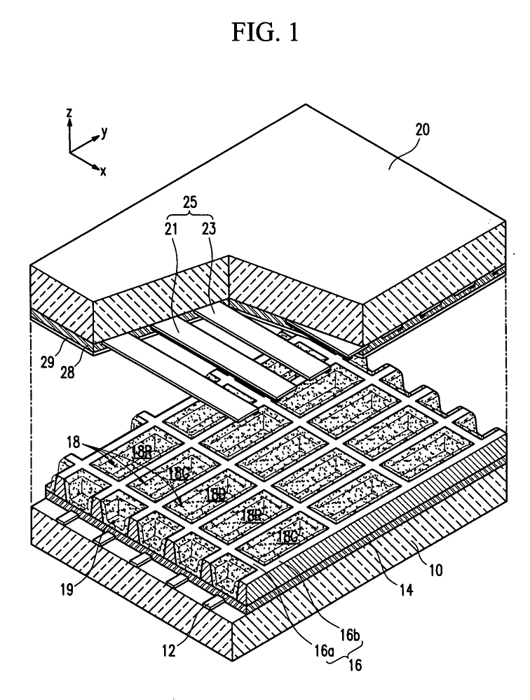

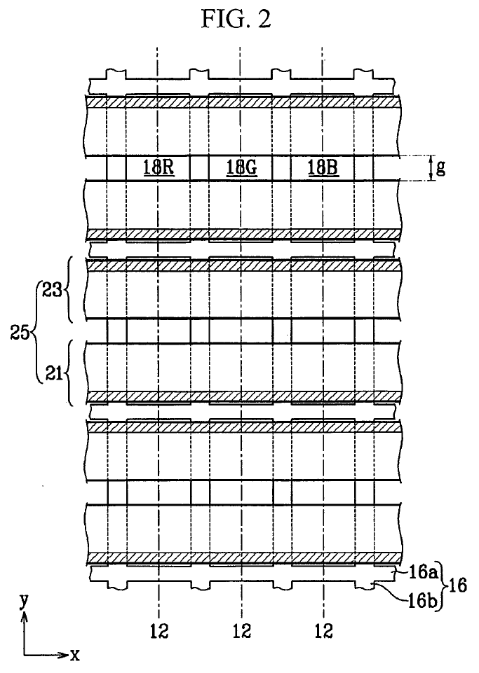

FIG. 1 illustrates a partial perspective view of a PDP according to an embodiment of the present invention. FIG. 2 illustrates a partial top plan view of an arrangement of display electrodes and discharge cells of the PDP of FIG. 1

Referring to FIGS. 1 and 2, front and rear substrates 20 and 10 may face each other. A space between the front and rear substrates 20 and 10 may be partitioned by barrier ribs 16 so as to define discharge cells 18. The discharge cells 18 may include sub-pixels that are the smallest units, and multiple sub-pixels may constitute one pixel. Address and display electrodes 12 and 25 may be formed to correspond to the discharge cells 18, and the display electrodes 25 may cross the address electrodes 12 at the discharge cells 18.

The front substrate 20 may be made of a transparent material, e.g., tempered glass, through which light may be transmitted. Images formed via discharge of the discharge cells 18 may be displayed through the front substrate 20, and the front substrate 20 may have a higher transmittance of visible light than the rear substrate 10.

When the front and rear substrates 20 and 10 are made of glass, the rear substrate 10 may have a greater thickness than the front substrate 20. The rear substrate 10 may have a greater strength than the front substrate 20, so the strength of the entire panel may be increased. The front substrate 20 may have a thickness of, e.g., about 1.8 mm, and the rear substrate 10 may have a thickness of, e.g., about 2.8 mm. A thickness ratio of the front substrate 20 to the rear substrate 10 may be, e.g., about 0.64.

In addition, the rear substrate 10 may be colored with a first color, which may be an achromatic color. Since the rear substrate colored with the achromatic color may have lower transmittance of visible light than the front substrate 20, the front substrate 20 may have a relatively high transmittance.

Further, the front and rear substrates 20 and 10 may be made of different materials. Since transmittances of visible light are different in accordance with the materials, the front substrate 20 may be made of a material having higher transmittance than the rear substrate 10.

When the front and rear substrates 20 and 10 are made of glass, the front and rear substrates 20 and 10 may be constructed so that the transmittance of the front substrate 20 may be equal to or greater than, e.g., about 93% (about 93% to about 100%), and the transmittance of the rear substrate 10 may be equal to or less than, e.g., about 90% (about 0.0001% to about 90%). A ratio of the transmittance of the front substrate 20 to the rear substrate 10 may range from, e.g., about 1.03 to about 1×10⁶.

When dielectric layers 28 and 14 are formed on inner surfaces of the front and rear substrates 20 and 10, respectively, the transmittance of the front substrate 20 and the dielectric layer 28 may be equal to or greater than, e.g., about 70% (about 70% to about 100%), and the transmittance of the rear substrate 10 and the dielectric layer 14 may be equal to or less than, e.g., about 30% (about 0.0001% to about 30%). A ratio of the transmittance of the front substrate 20 and the dielectric layer 28 to the rear substrate 10 and the dielectric layer 14 may range from, e.g., about 2.33 to about 1×10⁶.

The address electrodes 12 may be on the rear substrate 10, and may extend in a second direction (y-axis direction of FIG. 1) and may have a stripe shape. Since the address electrodes 12 may be spaced apart from each other by a predetermined interval, the address electrodes 12 may be arranged in a striped array.

The address electrodes 12 may be covered with and protected by the dielectric layer 14. The barrier ribs 16 may be between the rear and front substrates 10 and 20, to partition the space between the rear and front substrates 10 and 20 and define the discharge cells 18. The barrier ribs 16 may be arranged to form a predetermined pattern (for example, a stripe shape, a matrix shape, a delta shape, etc). In FIG. 1, barrier ribs 16 arranged to form an array shape are shown. However, the embodiments of the present invention are not restricted to the array shape.

The barrier ribs 16 may include first barrier ribs 16a that define the discharge cells 18 in a first direction (x-axis direction of FIG. 1) and second barrier ribs 16b that define the discharge cells 18 in the second direction. The second barrier ribs 16b may be between neighboring address electrodes 12 so that the address electrodes 12 cross the discharge cells 18.

Photoluminescent layers 19 that emit colored visible light may be formed in the discharge cells 18. The photoluminescent layers 19 of red, green, and blue photoluminescence may be formed in the discharge cells so as to display images. Red, green, and blue discharge cells 18R, 18G, and 18B together may form a pixel.

The discharge cells 18 in which the photoluminescent layers 19 are formed may be filled with a discharge gas, e.g., neon, xenon, a mixture thereof, etc.

The display electrodes 25, corresponding to the discharge cells 18, may be on the front substrate 20. The display electrodes 25 may extend in the first direction (x-axis direction in FIG. 1) to cross the address electrodes 12, and the display electrodes 25 may be constructed as pairs of scan and sustain electrodes 21 and 23. The scan and sustain electrodes 21 and 23 may face each other in the discharge cells 18 to form a discharge gap g (see FIG. 2). The scan electrodes 21 may interact with the address electrodes 12 so as to select the discharge cells 18 to be turned on. The sustain electrodes 23 may generate a sustain discharge with respect to the discharge cells selected by interaction with the scan electrodes 21 during a sustain period.

The display electrodes 25 may be covered with and protected by the dielectric layer 28 made of a dielectric material (e.g., PbO, B₂O₃, SiO₂, etc.). The dielectric layer 28 may prevent damage of the display electrodes 25 by preventing charged particles from colliding with the display electrodes 25.

The dielectric layer 28 may be covered with a passivation film 29 (e.g., MgO, etc.). The passivation film 29 may prevent damage of the dielectric layer 28 by preventing charged particles from directly colliding with the dielectric layer 28 during discharge. When the charged particles collide against the passivation film 29, the passivation film 29 may emit secondary electrons to increase discharge efficiency.

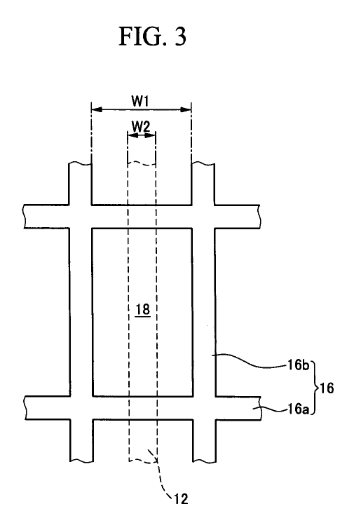

FIG. 3 illustrates a relationship between a width of the address electrodes 12 and the discharge cells 18.

Referring to FIG. 3, the address electrodes 12 may be between neighboring second barrier ribs 16b so that the address electrodes 12 cross, i.e., traverse, the discharge cells 18. The address electrodes 12 may shield bottom surfaces of the discharge cells from visible light transmitted toward the rear substrate 10, and the address electrodes 12 may reflect the visible light toward the front substrate 20.

The address electrodes 12 may be formed so that the loss of the visible light may be reduced. When an interval between neighboring second barrier ribs 16b is w1, and a width of each address electrode 12 is w2, the address electrodes 12 may be formed to satisfy a ratio condition of 0.6≦w2/w1≦1.36.

When w2/w1 is less than about 0.6, the address electrodes 12 corresponding to the discharge cells 18 may be excessively small, so an address discharge may not be suitably carried out. Since the visible light transmitted to the rear substrate 10 may not be adequately reflected by the small address electrodes, the amount of visible light reflected to the front substrate 20 may be reduced.

The address electrodes 12 may be formed to satisfy that w2/w1 is equal to or less than about 1.36 in consideration of the width of each second barrier rib 16b. When w2/w1 exceeds about 1.36, since the address electrodes 12 may extend into the neighboring discharge cells while passing over the second barrier ribs 16b, the address discharge may not be adequately performed.

Table 1 shows measurement results of transmittance change of visible light that transmits through the front substrate 20 as the width w2 of the address electrode is changed within a range that satisfies the condition 0.6≦w2/w1≦1.36. As is indicated by the experimental results, when the width w2 of the address electrode 12 increases by about 10 μm, the transmittance of the visible light increases by about 0.7%, on average.

TABLE 1

| Width of address electrode | Transmittance of visible | Increased |
|---|---|---|
| (μm) | light (%) | efficiency (%) |
| 90 | 94.12 | |
| 100 | 94.8 | 0.72 |
| 110 | 95.48 | 0.71 |
| 120 | 96.16 | 0.71 |
| 130 | 96.84 | 0.70 |
| 140 | 97.52 | 0.70 |
| 150 | 98.2 | 0.69 |

An analysis of the data in Table 1 indicates that that relationship between the width of the address electrode (μm) and the transmittance of visible light (%) is linear. The y=mx+b relationship may be observed to be y=0.068x+88, where x is the width of the address electrode (μm) and y is the transmittance of visible light (%).

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
a front substrate;
a rear substrate facing the front substrate, the rear substrate having a transmittance different from the front substrate;
barrier ribs that partition a space between the front and rear substrates to define discharge cells;
display electrodes that extend in a first direction corresponding to the discharge cells; and
address electrodes that extend in a second direction that crosses the first direction to cross the display electrodes at the discharge cells.

2. The plasma display panel as claimed in claim 1, wherein the transmittance of the front substrate is greater than the transmittance of the rear substrate.

3. The plasma display panel as claimed in claim 1, wherein the front and rear substrates are glass substrates.

4. The plasma display panel as claimed in claim 1, wherein the front substrate is thinner than the rear substrate.

5. The plasma display panel as claimed in claim 1, wherein a thickness of the front substrate is about 1.8 mm, and a thickness of the rear substrate is about 2.8 mm.

6. The plasma display panel as claimed in claim 1, wherein the transmittance of the front substrate is equal to or greater than about 93%, and the transmittance of the rear substrate is equal to or less than about 90%.

7. The plasma display panel as claimed in claim 1, wherein the transmittance of the front substrate and the dielectric layer is equal to or greater than about 70%.

8. The plasma display panel as claimed in claim 1, further comprising a dielectric layer covering the address electrodes on the rear substrate, and the transmittance of the rear substrate and the dielectric layer is equal to or less than about 30%.

9. The plasma display panel as claimed in claim 1,
wherein the barrier ribs include first barrier ribs that define the discharge cells in the second direction, and
when an interval between neighboring first barrier ribs is w1 and a width of each address electrode is w2, a ratio of 0.6≦w2/w1≦1.36 is satisfied.

10. The plasma display panel as claimed in claim 1, wherein the front and rear substrates are made of different materials.

11. The plasma display panel as claimed in claim 1, wherein the rear substrate is colored with an achromatic color.

12. A plasma display panel, comprising:
a front substrate;
a rear substrate that faces the front substrate;
barrier ribs that partition a space between the front and rear substrates to define discharge cells;
display electrodes that extend in a first direction corresponding to the discharge cells; and
address electrodes that extend in a second direction that crosses the first direction to cross the display electrodes at the discharge cells,
wherein the barrier ribs include barrier ribs that define the discharge cells in the second direction, and
wherein, when an interval between neighboring first barrier ribs is w1 and a width of each address electrode is w2, a ratio of 0.6≦w2/w1≦1.36 is satisfied.

13. The plasma display panel as claimed in claim 12, wherein the transmittance of the front substrate is greater than that of the rear substrate.

14. The plasma display panel as claimed in claim 12, wherein the front and rear substrates are glass substrates.

15. The plasma display panel as claimed in claim 12, wherein the front substrate is thinner than the rear substrate.

16. The plasma display panel as claimed in claim 12, wherein a thickness of the front substrate is about 1.8 mm, and a thickness of the rear substrate is about 2.8 mm.

17. The plasma display panel as claimed in claim 12, wherein a transmittance of the front substrate is equal to or greater than about 93%, and a transmittance of the rear substrate is equal to or less than about 90%.

18. The plasma display panel as claimed in claim 12, wherein a transmittance of the front substrate and the dielectric layer is equal to or greater than about 70%.

19. The plasma display panel as claimed in claim 12, further comprising a dielectric layer covering the address electrodes on the rear substrate, and a transmittance of the rear substrate and the dielectric layer is equal to or less than about 30%.

20. The plasma display panel as claimed in claim 12, wherein the front and rear substrates are made of different materials.
